(19) United States
(12) Patent Application Publication
(10) Pub. No.: US 2021/0224943 A1
(43) Pub. Date: Jul. 22, 2021

(54) SHARED VEHICLE MANAGING SYSTEM

(71) Applicant: HONDA MOTOR CO., LTD., Minato-ku, Tokyo (JP)

(72) Inventors: Masahiro YANAI, Saitama (JP); Isao UEMATSU, Saitama (JP); Yusuke KAWADA, Saitama (JP)

(21) Appl. No.: 15/734,284

(22) PCT Filed: Jun. 4, 2019
(86) PCT No.: PCT/JP2019/022202

§ 371 Date: Dec. 2, 2020

(30) Foreign Application Priority Data
Jun. 15, 2018 (JP) 2018-114920

(51) Int. Cl. G06Q 50/30; G06Q 10/06; G08G 1/127

(52) U.S. Cl. CPC G06Q 50/30; G08G 1/127; G06Q 10/06314

(57) ABSTRACT

To improve the convenience of a shared vehicle managing system, a shared vehicle managing system (1) for renting a plurality of shared vehicles (2) to a plurality of users includes: a plurality of user terminals (3) configured to generate use application information in response to an input operation by each user; and a managing server (6) connected to the user terminals via a network (7). The managing server includes an allocation processing unit (14) configured to allocate one shared vehicle to a user based on the use application information. The use application information does not include information about designation of the one shared vehicle but includes information about a scheduled travel distance.

### TECHNICAL FIELD

The present invention relates to a shared vehicle managing system.

### BACKGROUND ART

There is a shared vehicle managing system (car-sharing system) for renting a plurality of shared vehicles to a plurality of users (for example, Patent Document 1). Generally, in such a shared vehicle managing system, the user selects one shared vehicle he/she wants to use, and then applies to use the selected shared vehicle.

### PRIOR ART DOCUMENT(S)

### Patent Document(s)

Patent Document 1: JP2017-10189A

### SUMMARY OF THE INVENTION

### Task to be Accomplished by the Invention

However, it is troublesome for the user to select one shared vehicle by himself/herself, so that the motivation to use the shared vehicle managing system may be reduced. Further, the user tends to select one shared vehicle according to a vehicle type and external appearance. If one shared vehicle selected by the user in this way does not match the use purpose of the user, the satisfaction degree of the user may be decreased. Further, in the above system in which the user selects one shared vehicle by himself/herself, the total operation rate of the shared vehicles may be decreased and the deterioration of a specific shared vehicle may be prompted if use applications are concentrated on the specific shared vehicle.

In view of such a background, an object of the present invention is to improve the convenience of a shared vehicle managing system.

### Means for Accomplishing the Task

To achieve such an object, one embodiment of the present invention provides a shared vehicle managing system (1) for renting a plurality of shared vehicles (2) to a plurality of users, including: a plurality of user terminals (3) configured to generate use application information in response to an input operation by each user; and a managing server (6) connected to the user terminals via a network (7), wherein the managing server includes an allocation processing unit (14) configured to allocate one shared vehicle to a user based on the use application information, and the use application information does not include information about designation of the one shared vehicle but includes information about a scheduled travel distance.

According to this arrangement, the user does not have to select the shared vehicle to board when making a use application, thereby smoothly carrying out a task of making the use application. Accordingly, it is possible to improve the convenience of the shared vehicle managing system.

In the above arrangement, preferably, the managing server includes a shared vehicle information managing unit (12) configured to store vehicle information about each shared vehicle, the vehicle information includes information about whether each shared vehicle is a long-distance vehicle, and the allocation processing unit is configured to acquire the scheduled travel distance based on the use application information and to allocate the one shared vehicle preset as the long-distance vehicle to the user in a case where the scheduled travel distance is longer than a prescribed determination value.

According to this arrangement, the shared vehicle preset as the long-distance vehicle is allocated to the user in a case where the scheduled travel distance is long. Accordingly, the shared vehicle suitable for long-distance travel can be allocated to the user who plans to travel long-distance. Further, the shared vehicle, which is specified by the administrator as a vehicle to be prevented from increasing the total travel distance, is not allocated to the user who plans to travel long-distance. For example, by suppressing the total travel distance of a high-grade shared vehicle, it is possible to maintain the vehicle value thereof.

In the above arrangement, preferably, the managing server includes a shared vehicle information managing unit configured to store vehicle information about each shared vehicle, the vehicle information includes at least one of a total travel distance and a remaining amount of energy, and the allocation processing unit is configured to allocate the one shared vehicle to the user based on the use application information and the vehicle information. For example, in a case where the shared vehicle is a gasoline vehicle or a diesel vehicle, the remaining amount of energy is a remaining amount of fuel. In a case where the shared vehicle is an electric vehicle, the remaining amount of energy is a remaining amount of a battery.

According to this arrangement, the allocation processing unit can provide a shared vehicle that is suitable for the user.

In the above arrangement, preferably, the allocation processing unit is configured to calculate a travel distance difference by subtracting the total travel distance from a target total travel distance set for each shared vehicle according to an operation period thereof and to allocate the one shared vehicle with a large travel distance difference to the user.

According to this arrangement, with regard to each shared vehicle, the total travel distance can get closer to the target total travel distance.

In the above arrangement, preferably, the allocation processing unit is configured to acquire the scheduled travel distance based on the use application information, to set a travelable distance for each shared vehicle based on the remaining amount of the energy, and to allocate the one shared vehicle to the user, a difference between the travelable distance of the one shared vehicle and the scheduled travel distance thereof being within a prescribed range.

According to this arrangement, the user refuel or recharge the shared vehicle with less frequency during a use period, which improves convenience.

In the above arrangement, preferably, the use application information includes destination information, the vehicle information includes information about whether each shared vehicle is provided with cold region equipment, and the allocation processing unit is configured to acquire weather information about a destination in a use period based on the destination information, to determine whether there is a need for the cold region equipment based on the weather information, and to allocate the one shared vehicle provided with the cold region equipment to the user in a case where there is the need for the cold region equipment. The cold region equipment may include studless tires and/or snow chains.

According to this arrangement, the shared vehicle provided with the cold region equipment can be allocated to the user who plans to travel in a cold region even if the user does not designate such a shared vehicle.

In the above arrangement, preferably, the managing server includes a user information managing unit (11) configured to store driving skill information about a driving skill of each user, and the allocation processing unit is configured to allocate the one shared vehicle to the user based on the use application information and the driving skill information.

According to this arrangement, the shared vehicle can be allocated according to the driving skill of the user. For example, it is possible to allocate the share vehicle provided with safety equipment (for example, a collision preventing device) to the user with a low driving skill. Further, the grade of the shared vehicle to be allocated may be changed according to the driving skill.

In the above arrangement, preferably, the managing server includes a shared vehicle information managing unit configured to store vehicle information about each shared vehicle, the vehicle information includes a use history of each shared vehicle, and the allocation processing unit is configured to acquire a standby period of each shared vehicle based on the use history and to allocate the one shared vehicle to the user, the standby period of the one shared vehicle being longer than a prescribed determination value.

According to this arrangement, the shared vehicle with a long standby period is more likely to be allocated to the user. Accordingly, the standby period of each shared vehicle is reduced, so that the battery of each shared vehicle can be prevented from discharging too much.

In the above arrangement, preferably, the shared vehicle managing system further includes an administrator terminal connected to the managing server via the network and configured to generate allocation policy information in response to an input operation by an administrator, wherein the allocation processing unit is configured to allocate the one shared vehicle to the user also based on the allocation policy information.

According to this arrangement, it is possible to allocate the shared vehicle to the user in consideration of the request from the administrator. For example, the administrator may be able to change the shared vehicle to be prevented from increasing the total travel distance.

### Effect of the Invention

Thus, according to the above arrangements, it is possible to improve the convenience of the shared vehicle managing system.

### BRIEF DESCRIPTION OF THE DRAWING(S)

FIG. 1 is a block diagram of a shared vehicle managing system according to an embodiment;

FIG. 2 is an explanatory diagram illustrating a reservation accepting screen displayed on a user interface of each user terminal;

FIG. 3 is a flowchart of an allocation process;

FIG. 4 is a flowchart of a narrowing process;

FIG. 5 is a flowchart of a first narrowing subroutine;

FIG. 6 is a flowchart of a second narrowing subroutine;

FIG. 7 is a flowchart of a third narrowing subroutine;

FIG. 8 is a flowchart of a fourth narrowing subroutine;

FIG. 9 is a flowchart of a fifth narrowing subroutine; and

FIG. 10 is a flowchart of a sixth narrowing subroutine.

### MODE(S) FOR CARRYING OUT THE INVENTION

### The Overall Configuration of the Shared Vehicle Managing System

In the following, with reference to the drawings, an embodiment of a shared vehicle managing system 1 will be described. The shared vehicle managing system 1 is managed by a group that owns a plurality of shared vehicles 2, and is configured to provide a service (namely, a car-sharing service) for renting the plurality of shared vehicles 2 to a plurality of users registered in advance. The abovementioned group may be a company, a government office, a sports club, a nursing home, a shopping center, a car-sharing provider, or the like. The group owns at least one station for parking the shared vehicles 2. Each station has the plurality of shared vehicles 2. User identification numbers are set for all the users, shared vehicle identification numbers are set for all the shared vehicles 2, and station identification numbers are set for all the stations. These numbers are respectively registered in the shared vehicle managing system 1. The shared vehicle managing system 1 is configured to accept a use application from each user, and allocates one shared vehicle 2 to the user who has made the use application.

Each shared vehicle 2 may be a gasoline vehicle or a diesel vehicle that uses fuel such as gasoline or light oil, or may be an electric vehicle that uses electric power of a battery.

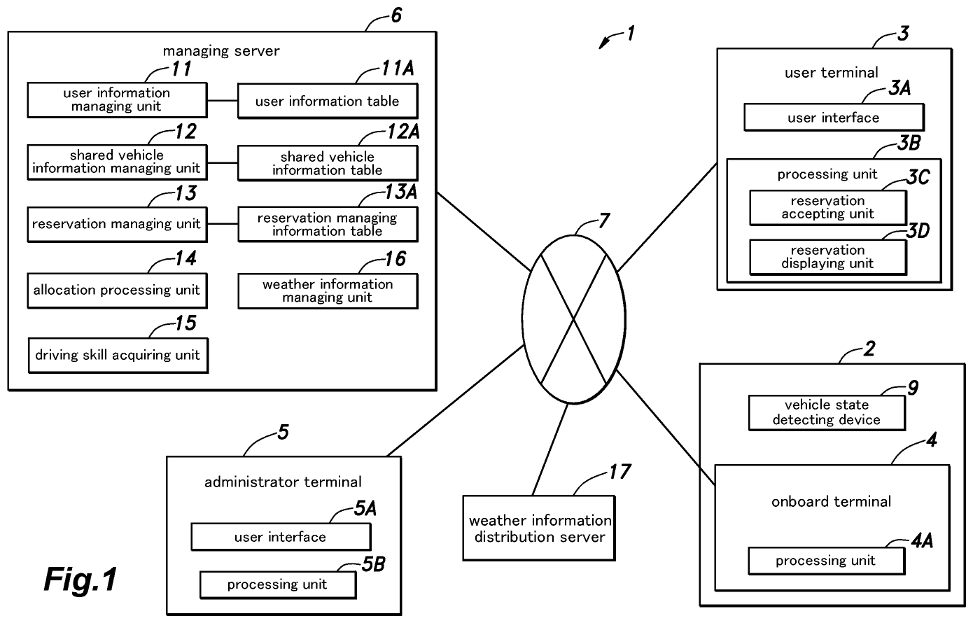

As shown in FIG. 1, the shared vehicle managing system 1 includes a plurality of user terminals 3, a plurality of onboard terminals 4 respectively mounted on the plurality of shared vehicles 2, at least one administrator terminal 5, and a managing server 6. The plurality of user terminals 3, the plurality of onboard terminals 4, the administrator terminal 5, and the managing server 6 are connected to each other via a network 7. For example, the network 7 is the Internet. Each user owns the user terminal 3, and an administrator owns the administrator terminal 5. The managing server 6 may be a server provided in the building of the group that manages the shared vehicle managing system 1, or may be a cloud server.

Each user terminal 3 includes a user interface 3A configured to display an input screen and a message and to accept an input operation by each user, and a processing unit 3B composed of an arithmetic unit, memory, and the like. For example, the user terminal 3 consists of a smartphone, a mobile phone, or a personal computer. The processing unit 3B includes a reservation accepting unit 3C and a reservation displaying unit 3D. The reservation accepting unit 3C is configured to transmit use application information, which is generated in response to the input operation on the user interface 3A by the user, to the managing server 6. The reservation displaying unit 3D is configured to cause the user interface 3A to display reservation confirmation screen upon receiving reservation confirmation information from the managing server 6. In the present embodiment, the reservation accepting unit 3C and the reservation displaying unit 3D respectively consist of software executed in the processing unit 3B.

The use application information includes basic information and additional information. The basic information includes the user name (the user identification number), the name of the station to be used (the station identification number), the use start date and time, and the use end date and time. The additional information includes information about a scheduled travel distance and information about a use purpose. The use application information does not include designation information for designating a specific shared vehicle 2 the user wants to use. The basic information is essential to the use application information, and the additional information is included in the use application information according to the user's selection. The information about the scheduled travel distance includes at least one of the scheduled travel distance represented by a numerical value, the destination, the presence/absence of long-distance travel, and the travel route. The information about the use purpose includes the number of users, the presence/absence of baggage, and the use purpose (leisure, commuting, transportation of baggage, or the like). The additional information may further include information about the user's request. For example, the information about the user's request may include information about the grade of the shared vehicle 2 the user wants to use, information about necessity of safety equipment such as a collision preventing device, and information about necessity of cold region equipment such as studless tires or snow chains.

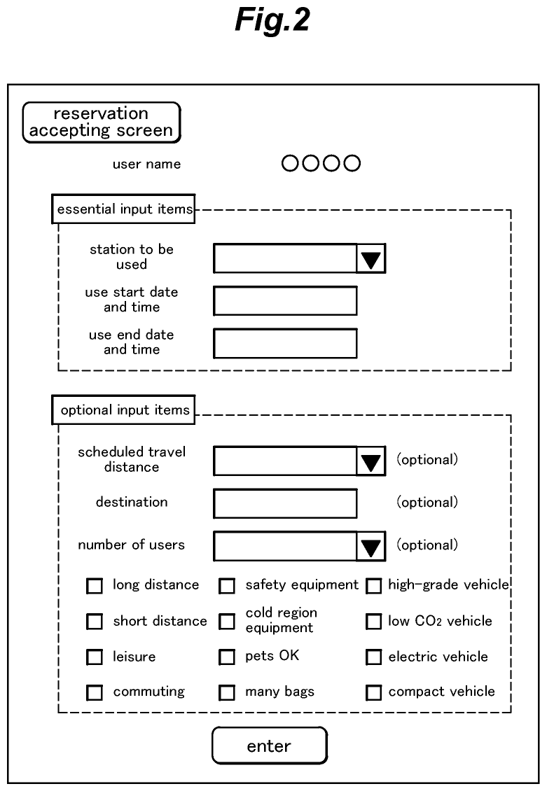

As shown in FIG. 2, the reservation accepting unit 3C is configured to cause the user interface 3A to display a reservation accepting screen (use application screen). The reservation accepting screen includes input boxes and check boxes, which are respectively related to items of the use application information. In the present embodiment, the user name is automatically set for each user terminal 3. The name of the station to be used, the use start date and time, and the use end date and time, which are included in the basic information, are set to essential input items to be indispensably input by each user. The scheduled travel distance, the destination, or the like, which are included in the additional information, are set to optional input items to be optionally input by the user. The reservation accepting unit 3C is configured to generate the use application information in response to the input operation by the user and to transmit the use application information to the managing server 6.

After each user terminal 3 receives the reservation confirmation information from the managing server 6, the reservation displaying unit 3D causes the user interface 3A to display the reservation confirmation screen. The reservation confirmation information includes the user name (the user identification number), the name of the station to be used (the station identification number), the use start date and time, the use end date and time, information for identifying the allocated shared vehicle 2, and information about the equipment of the allocated shared vehicle 2. The information for identifying the allocated shared vehicle 2 includes a vehicle type, a vehicle color, a vehicle registration number, and the like. The information about the equipment of the allocated shared vehicle 2 includes information about the safety equipment and the cold region equipment.

Each onboard terminal 4 includes a processing unit 4A composed of an arithmetic unit, memory, and the like. For example, the onboard terminal 4 is a vehicle navigation device. Each shared vehicle 2 is provided with a vehicle state detecting device 9 configured to acquire a vehicle state. The vehicle state detecting device 9 includes an energy remaining amount sensor configured to detect a remaining amount of energy such as fuel or a battery, a vehicle speed sensor configured to detect a vehicle speed, an odometer configured to measure a total travel distance, and an impact detecting sensor (acceleration sensor) configured to detect an impact applied to the shared vehicle 2. The vehicle state detecting device 9 is connected to the onboard terminal 4, and is configured to input detected vehicle state information to the processing unit 4A of the onboard terminal 4. The processing unit 4A of the onboard terminal 4 is configured to transmit the vehicle state information to the managing server 6. The vehicle state information includes the remaining amount of energy (fuel or a battery), the vehicle speed, the presence/absence of the impact, and the like.

The administrator terminal 5 includes a user interface 5A configured to display an input screen and a message and to accept an input operation by the administrator, and a processing unit 5B composed of an arithmetic unit, memory, and the like. For example, the administrator terminal 5 consists of a smartphone, a mobile phone, or a personal computer. The processing unit 5B of the administrator terminal 5 is configured to transmit allocation policy information, which is generated in response to an input operation on the user interface 5A by the administrator, to the managing server 6.

The managing server 6 is a computer including a central processing unit, memory, a hard disk, and the like. The managing server 6 includes a user information managing unit 11 configured to hold information about each user, a shared vehicle information managing unit 12 configured to hold shared vehicle information (vehicle information) about each shared vehicle 2, a reservation managing unit 13 configured to manage a reservation of the shared vehicle 2, an allocation processing unit 14 configured to determine the shared vehicle 2 to be allocated to the user, a driving skill acquiring unit 15 configured to acquire a driving skill of the user based on a driving state of the user, and a weather information managing unit 16 configured to store weather information.

The user information managing unit 11 has a user information table 11A. The user information table 11A stores information about each user as user information. the user information includes the user identification number, the user name, and the driving skill.

The shared vehicle information managing unit 12 has a shared vehicle information table 12A. The shared vehicle information table 12A stores the vehicle information related to each shared vehicle 2 as the shared vehicle information. The shared vehicle information includes the shared vehicle identification number, the station identification number of the station where the shared vehicle 2 is located, the use history of the shared vehicle 2, the current reservation status of the shared vehicle 2, the total travel distance, the date and time of operation start, the remaining amount of energy, information about the presence/absence of the safety equipment, information about the presence/absence of the cold region equipment, and the specification of the shared vehicle 2.

Upon receiving the use application information from each user terminal 3, the reservation managing unit 13 generates reservation managing information based on the use application information, and stores the reservation managing information in a reservation managing information table 13A. The reservation managing information includes the application number, the user identification number, the use start date and time, the use end date and time, the success/failure of the reservation, and the shared vehicle identification number of the allocated shared vehicle 2. Immediately after the reservation managing unit 13 receives the use application information and generates the reservation managing information, the initial value corresponding to “absence” is stored as information about the success/failure of the reservation and the shared vehicle identification number of the allocated shared vehicle 2.

The reservation managing unit 13 outputs an allocation process request and the use application information to the allocation processing unit 14 after generating the reservation managing information. The allocation processing unit 14 executes an allocation process described later, and then outputs an allocation result to the reservation managing unit 13. The allocation result includes the application number, and further includes the shared vehicle identification number of the allocated shared vehicle 2 or information corresponding to the failure of the allocation of the shared vehicle 2. The reservation managing unit 13 determines the success/failure of the reservation based on the allocation result and updates the success/failure of the reservation and the shared vehicle identification number of the allocated shared vehicle 2, which are included in the reservation managing information stored in the reservation managing information table 13A. After that, the reservation managing unit 13 transmits the reservation managing information to each user terminal 3 as reservation result information (reservation confirmation information).

When a certain user is driving the shared vehicle 2, the driving skill acquiring unit 15 determines the driving skill of the user driving the shared vehicle 2 based on the vehicle state information input from each onboard terminal 4. For example, the driving skill is represented by an integer value from 1 to 5. The larger the integer value is, the higher the driving skill represented thereby is. For example, the driving skill acquiring unit 15 detects sudden starts and sudden stops of the shared vehicle 2 based on vehicle speed information and evaluates the driving skill such that the driving skill gets higher as the number of sudden starts and sudden stops thereof per hour gets smaller. Alternatively, the driving skill acquiring unit 15 may evaluate the driving skill based on the magnitude and the number of impacts applied to the shared vehicle 2, which is detected by the impact detecting sensor. The driving skill acquiring unit 15 updates the driving skill stored as the user information about the user to be a target based on the acquired driving skill. The driving skill acquiring unit 15 may calculate an average value of the driving skill stored as the user information and the acquired driving skill, and then update the driving skill stored as the user information based on the calculated average value.

The weather information managing unit 16 acquires the current and future weather information about each point from a weather information distribution server 17 via the network 7, and stores the acquired weather information.

(The Allocation Process)

Upon receiving the allocation process request and the use application information, the allocation processing unit 14 executes an allocation program based on the use application information, the user information in the user information table 11A, and the shared vehicle information in the shared vehicle information table 12A. Accordingly, the allocation processing unit 14 determines one shared vehicle 2 to be allocated to a user.

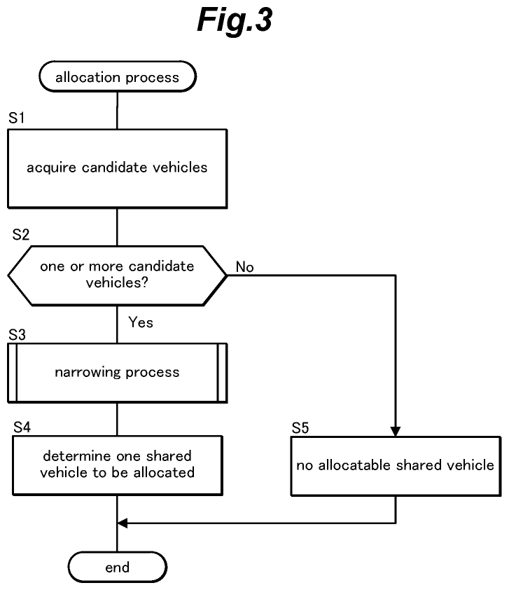

The allocation processing unit 14 executes the allocation process for allocating the one shared vehicle 2 to the user based on the allocation program. As shown in FIG. 3, in the allocation process, the allocation processing unit 14 first narrows down the shared vehicles 2 based on all the user desired conditions included in the use application information, thereby acquiring one or more candidate vehicles (S1). The user desired conditions include at least the use start date and time, the use end date and time, and all the selected stations. Further, the user desired conditions may include the number of users, the presence/absence of the safety equipment, and the presence/absence of the cold region equipment. For example, the allocation processing unit 14 searches the shared vehicle information table 12A based on the use start date and time, the use end date and time, and the station identification numbers of the selected stations, thereby extracting available shared vehicles 2 as the candidate vehicles.

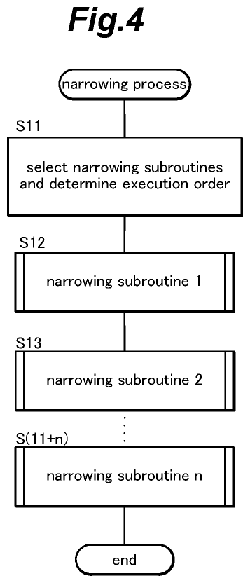

In a case where one or more candidate vehicles are present (Yes in S2), the allocation processing unit 14 executes a narrowing process (see FIG. 4) described later, thereby narrowing down the candidate vehicles (S3). Then, the allocation processing unit 14 determines the one shared vehicle 2 to be allocated to the user from the candidate vehicles that have been narrowed down (S4). Various methods can be adopted for determining the one shared vehicle 2 in S4. For example, the allocation processing unit 14 may randomly select the one shared vehicle 2 from the candidate vehicles that have been narrowed down. Alternatively, the allocation processing unit 14 may select one candidate vehicle with the longest standby period after the previous use as the one shared vehicle 2. Then, the allocation processing unit 14 outputs the allocation result, which includes the application number and the shared vehicle identification number of the allocated shared vehicle 2, to the reservation managing unit 13.

In a case where no candidate vehicle is present (S2 is No), the allocation processing unit 14 determines that no allocatable shared vehicle 2 is present and outputs the allocation result, which includes the application number and information corresponding to the absence of the allocatable shared vehicle 2, to the reservation managing unit 13 (S5).

Upon receiving the allocation result, the reservation managing unit 13 causes a reservation to succeed based on the shared vehicle identification number of the allocated shared vehicle 2, and stores the success of the reservation and the shared vehicle identification number of the allocated shared vehicle 2 in the reservation managing information table 13A. On the other hand, the reservation managing unit 13 causes the reservation to fail based on the information corresponding to the absence of the allocatable shared vehicle 2, and stores the failure of the reservation and the absence of the shared vehicle identification number of the allocated shared vehicle 2 in the reservation managing information table 13A.

(The Narrowing Process)

FIG. 4 is a flowchart showing the narrowing process corresponding to S3 of the allocation process. In the narrowing process, one or more narrowing subroutines are executed in the selected order. For example, the narrowing subroutines include the first to sixth narrowing subroutines described later. In the narrowing process, the allocation processing unit 14 first selects the narrowing subroutines to be executed and determines the execution order of the narrowing subroutines based on the allocation policy information (S11).

The allocation policy information is generated by the administrator terminal 5 in response to the input operation by the administrator. The allocation policy information includes information required to select the narrowing subroutines to be executed and to determine the execution order of the narrowing subroutines. The processing unit 5B of the administrator terminal 5 may directly receive inputs (an input about whether to execute each narrowing subroutine and an input about the execution order of the narrowing subroutines) from the administrator so as to generate the allocation policy information. Alternatively, the processing unit 5B of the administrator terminal 5 may ask the administrator a plurality of questions about the allocation of each shared vehicle 2 so as to generate the allocation policy information based on the answers to the plurality of questions. In a case where the allocation processing unit 14 does not receive the allocation policy information from the administrator terminal 5, the allocation processing unit 14 selects the narrowing subroutines to be executed and determines the execution order of the narrowing subroutines based on an initial value.

In the narrowing process, the allocation processing unit 14 selects the narrowing subroutines to be executed and determines the execution order of the narrowing subroutines (S11). After that, the allocation processing unit 14 executes the selected narrowing subroutines in the determined execution order (S12 to S(11+n)). The allocation processing unit 14 completes the narrowing process after executing all the selected narrowing subroutines.

In the following, the first to sixth narrowing subroutines are shown as examples of the narrowing subroutines. Incidentally, the ordinal numbers added to the narrowing subroutines do not represent the execution order of the narrowing subroutines.

(The First Narrowing Subroutine)

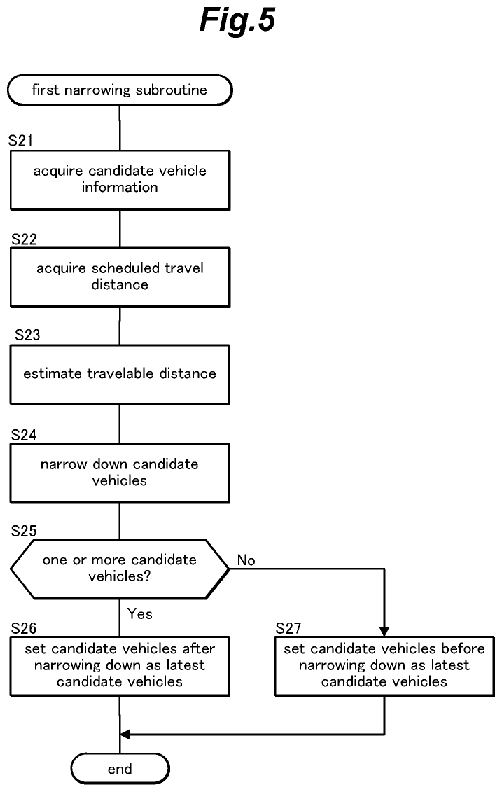

In the first narrowing subroutine, the allocation processing unit 14 further narrows down the candidate vehicles based on the information about the scheduled travel distance included in the use application information and the remaining amount of energy included in the shared vehicle information. As shown in FIG. 5, in the first narrowing subroutine, the allocation processing unit 14 first acquires the latest candidate vehicle information (S21). In a case where the first narrowing subroutine is executed first in the narrowing process, the latest candidate vehicle information is the candidate vehicle information set in step S1. In a case where the first narrowing subroutine is executed second or later in the narrowing process, the latest candidate vehicle information is the candidate vehicle information set in the previous narrowing subroutine.

Next, the allocation processing unit 14 acquires the scheduled travel distance based on the information about the scheduled travel distance included in the use application information (S22). In a case where the information about the scheduled travel distance includes the scheduled travel distance represented by the numerical value, the allocation processing unit 14 may set the numerical value to the scheduled travel distance. Further, in a case where the information about the scheduled travel distance includes information about the destination, the allocation processing unit 14 may acquire the scheduled travel distance based on the selected stations and destination. Further, in a case where the information about the scheduled travel distance includes information such as “long-distance travel”, the allocation processing unit 14 may set a prescribed value such as “200 km” to the scheduled travel distance.

Next, the allocation processing unit 14 estimates a travelable distance of each candidate vehicle based on the remaining amount of energy included in the shared vehicle information (S23). For example, the allocation processing unit 14 may set the travelable distance from the remaining amount of energy based on a map predetermining a relationship between the remaining amount of energy and the travelable distance.

Next, the allocation processing unit 14 calculates a difference between the travelable distance of each candidate vehicle and the scheduled travel distance thereof, and narrows down the candidate vehicles on condition that the above difference is within a prescribed determination range (S24). The abovementioned determination range may be changed according to the scheduled travel distance. For example, in a case where the scheduled travel distance is equal to or less than a prescribed threshold, the determination range may be made smaller as compared with a case where the scheduled travel distance is greater than the abovementioned threshold.

In a case where one or more candidate vehicles are present after narrowing down in S24 (the determination in S25 is Yes), the allocation processing unit 14 stores the candidate vehicles after narrowing down in S24 as the latest candidate vehicles (S26). On the other hand, in a case where no candidate vehicle is present after narrowing down in S24 (the determination in S25 is No), the allocation processing unit 14 stores the candidate vehicles before narrowing down in S24 as the latest candidate vehicles (S27).

According to the first narrowing subroutine, the candidate vehicles are narrowed down to the shared vehicles 2 having the remaining amount of energy corresponding to the scheduled travel distance of each user. Thus, the shared vehicle 2 with a large remaining amount of energy is more likely to be allocated to the user who plans to travel long-distance, while the shared vehicle 2 with a small remaining amount of energy is more likely to be allocated to the user who plans to travel short-distance. Accordingly, the user who plans to travel long-distance does not necessarily fill the shared vehicle 2 with energy (electric power or fuel), and thus it is possible to improve convenience. Further, the shared vehicle 2 with a small remaining amount of energy is allocated to the user who plans to travel short-distance, and thus the shared vehicle 2 with a large remaining amount of energy is more likely to remain in the station. Accordingly, in the allocation process from the next time onward, the shared vehicle 2 with a large remaining amount of energy is more likely to be allocated to the user who wants to travel long-distance. Thus, the loss of use opportunities can be reduced.

(The Second Narrowing Subroutine)

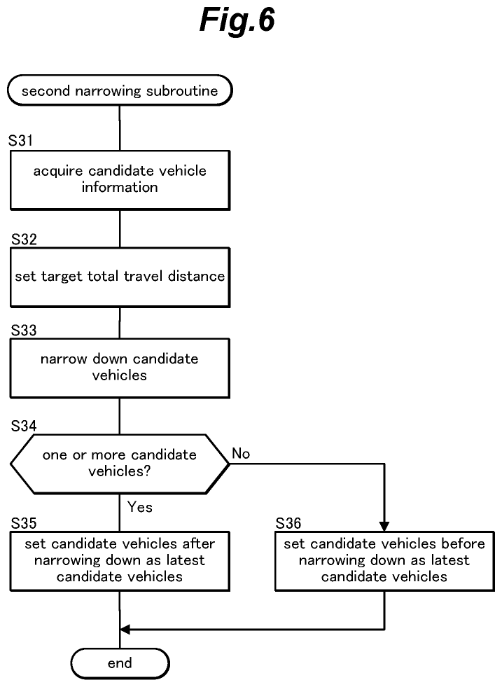

In the second narrowing subroutine, the allocation processing unit 14 further narrows down the candidate vehicles based on the total travel distance included in the shared vehicle information. As shown in FIG. 6, in the second narrowing subroutine, the allocation processing unit 14 first acquires the latest candidate vehicle information (S31). In a case where the second narrowing subroutine is executed first in the narrowing process, the latest candidate vehicle information is the candidate vehicle information set in step S1. In a case where the second narrowing subroutine is executed second or later in the narrowing process, the latest candidate vehicle information is the candidate vehicle information set in the previous narrowing subroutine.

Next, the allocation processing unit 14 sets a target total travel distance for each candidate vehicle based on the date and time of operation start in the shared vehicle information (S32). For example, the allocation processing unit 14 calculates an operation period based on the date and time of operation start and the current date, and sets the target total travel distance by multiplying the operation period and a prescribed coefficient together.

Next, the allocation processing unit 14 acquires the current total travel distance from the shared vehicle information, and narrows down the candidate vehicles on condition that a travel distance difference, which is calculated by subtracting the current total travel distance from the target total travel distance, is a positive value (S33). Namely, the allocation processing unit 14 narrows down the candidate vehicles on condition that the current total travel distance is less than the target total travel distance.

In a case where one or more candidate vehicles are present after narrowing down in S33 (the determination in S34 is Yes), the allocation processing unit 14 stores the candidate vehicles after narrowing down in S33 as the latest candidate vehicles (S35). On the other hand, in a case where no candidate vehicle is present after narrowing down in S33 (the determination in S34 is No), the allocation processing unit 14 stores the candidate vehicles before narrowing down in S33 as the latest candidate vehicles (S36).

According to the second narrowing subroutine, the candidate vehicles are narrowed down to the shared vehicles 2 whose current total travel distance is less than the target total travel distance. Accordingly, the operation rate of the shared vehicle 2 with a low operation rate can be improved. Further, the total travel distance of each shared vehicle 2 is equalized, so that the deterioration of some shared vehicles 2 and the decrease in the resale values thereof can be prevented.

(The Third Narrowing Subroutine)

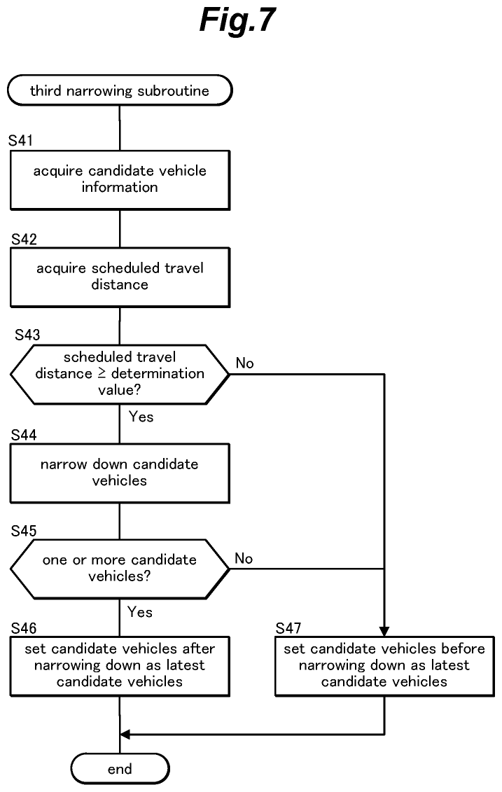

In the third narrowing subroutine, the allocation processing unit 14 further narrows down the candidate vehicles based on the information about the scheduled travel distance included in the use application information and the vehicle information included in the shared vehicle information. As shown in FIG. 7, in the third narrowing subroutine, the allocation processing unit 14 first acquires the latest candidate vehicle information (S41). In a case where the third narrowing subroutine is executed first in the narrowing process, the latest candidate vehicle information is the candidate vehicle information set in step S1. In a case where the third narrowing subroutine is executed second or later in the narrowing process, the latest candidate vehicle information is the candidate vehicle information set in the previous narrowing subroutine.

Next, the allocation processing unit 14 acquires the scheduled travel distance based on the information about the scheduled travel distance included in the use application information (S42). The process of S42 is the same as the abovementioned process of S22, and thus the description of S22 is applied to that of S42.

Next, the allocation processing unit 14 determines whether the scheduled travel distance is equal to or greater than a prescribed determination value (S43). The determination value is a value set for determining whether the scheduled travel distance corresponds to a long distance. For example, the determination value is set to 100 km or the like. In a case where the scheduled travel distance is equal to or greater than the determination value (the determination in S43 is Yes), the allocation processing unit 14 narrows down the candidate vehicles to the long-distance vehicles as new candidate vehicles based on the shared vehicle information (S44). In a case where the scheduled travel distance is less than the determination value (determination in S43 is No), the allocation processing unit 14 proceeds to S47 without narrowing down the candidate vehicles.

In a case where one or more candidate vehicles are present after narrowing down in S44 (the determination in S45 is Yes), the allocation processing unit 14 stores the candidate vehicles after narrowing down in S44 as the latest candidate vehicles (S46). On the other hand, in a case where no candidate vehicle is present after narrowing down in S44 (the determination in S45 is No), the allocation processing unit 14 stores the candidate vehicles before narrowing down in S44 as the latest candidate vehicles (S47). Further, in a case where the scheduled travel distance is less than the determination value (the determination in S43 is No), the allocation processing unit 14 stores the candidate vehicles before narrowing down in S44 as the latest candidate vehicles (S47).

According to the third narrowing subroutine, in a case where the scheduled travel distance of each user is equal to or greater than the determination value, the candidate vehicles are narrowed down to the long-distance vehicles on the presumption that the user plans to travel long-distance. By setting the shared vehicles 2 suitable for long-distance travel as the long-distance vehicles, the driving load of the user can be reduced and the convenience can be improved. Further, by not setting a specific shared vehicle 2, whose total travel distance should be kept low, to the long-distance vehicle, the specific shared vehicle 2 is unlikely to be allocated to long-distance travel. Accordingly, an increase in the total travel distance of the specific shared vehicle 2 can be suppressed. For example, the shared vehicle 2 whose total travel distance should be kept low is a high-grade shared vehicle 2 (an expensive shared vehicle 2) or the like.

(The Fourth Narrowing Subroutine)

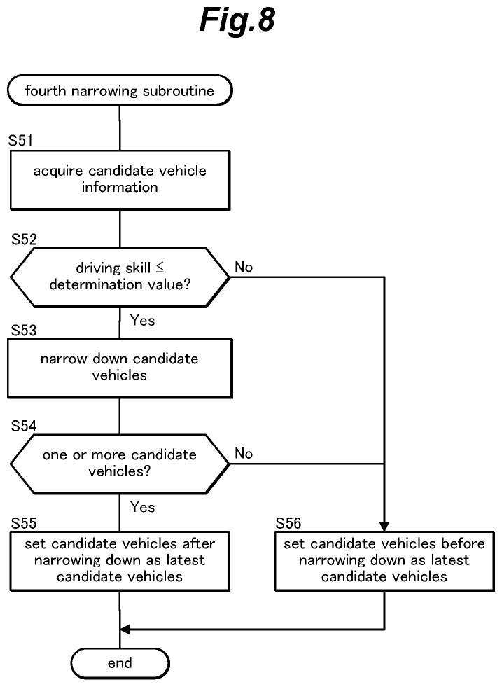

In the fourth narrowing subroutine, the allocation processing unit 14 further narrows down the candidate vehicles based on the driving skill included in the user information. As shown in FIG. 8, in the fourth narrowing subroutine, the allocation processing unit 14 first acquires the latest candidate vehicle information (S51). In a case where the fourth narrowing subroutine is executed first in the narrowing process, the latest candidate vehicle information is the candidate vehicle information set in step S1. In a case where the fourth narrowing subroutine is executed second or later in the narrowing process, the latest candidate vehicle information is the candidate vehicle information set in the previous narrowing subroutine.

Next, the allocation processing unit 14 determines whether the driving skill is equal to or lower than a prescribed determination value (S52). For example, the driving skill is represented by the integer value from 1 to 5. The larger the integer value is, the higher the driving skill represented thereby is. For example, the determination value is set to 2.

In a case where the driving skill is equal to or lower than the determination value (the determination in S52 is Yes), the allocation processing unit 14 narrows down the candidate vehicles to the shared vehicles 2 provided with the safety equipment as new candidate vehicles (S53). On the other hand, in a case where the driving skill is higher than the determination value (the determination in S52 is No), the allocation processing unit 14 proceeds to S56 without narrowing down the candidate vehicles.

In a case where one or more candidate vehicles are present after narrowing down in S53 (the determination in S54 is Yes), the allocation processing unit 14 stores the candidate vehicles after narrowing down in S53 as the latest candidate vehicles (S55). On the other hand, in a case where no candidate vehicle is present after narrowing down in S53 (the determination in S54 is No), the allocation processing unit 14 stores the candidate vehicles before narrowing down in S53 as the latest candidate vehicles (S56). Further, in a case where the driving skill is higher than the determination value (the determination in S52 is No), the allocation processing unit 14 stores the candidate vehicles before narrowing down in S53 as the latest candidate vehicles (S56).

According to the fourth narrowing subroutine, in a case where the driving skill of the user is equal to or lower than the determination value, the candidate vehicles are narrowed down to the shared vehicles 2 provide with the safety equipment on the presumption that the driving skill of the user is low. Thus, the shared vehicle 2 provided with the safety equipment is more likely to be allocated to the user whose driving skill is presumed to be low. Accordingly, the occurrence rate of traffic accidents caused by the whole users is reduced, so that the safety of the user can be enhanced and the operation cost of the shared vehicle managing system 1 can be reduced.

(The Fifth Narrowing Subroutine)

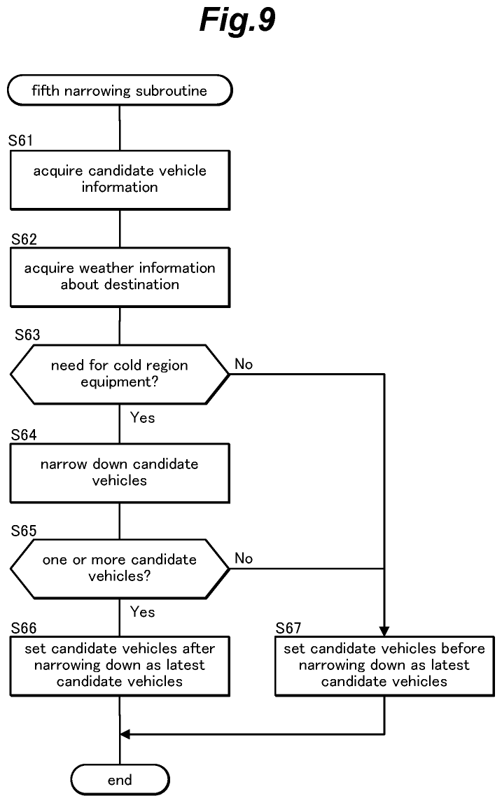

In the fifth narrowing subroutine, the allocation processing unit 14 further narrows down the candidate vehicles based on the destination included in the use application information. As shown in FIG. 9, in the fifth narrowing subroutine, the allocation processing unit 14 first acquires the latest candidate vehicle information (S61). In a case where the fifth narrowing subroutine is executed first in the narrowing process, the latest candidate vehicle information is the candidate vehicle information set in step S1. In a case where the fifth narrowing subroutine is executed second or later in the narrowing process, the latest candidate vehicle information is the candidate vehicle information set in the previous narrowing subroutine.

Next, the allocation processing unit 14 searches the weather information stored in the weather information managing unit 16 based on the destination included in the use application information, thereby acquiring the weather information about the destination (S62). The weather information about the destination includes the weather, the temperature, the snowfall, or the like.

Next, the allocation processing unit 14 determines whether there is a need for the cold region equipment based on the weather information about the destination (S63). For example, in a case where at least one of the following conditions 1 to 3 is satisfied, the allocation processing unit 14 may determine that there is the need for the cold region equipment.

[condition 1] The weather of the destination is snow.

[condition 2] The snowfall of the destination is greater than zero.

[condition 3] The temperature of the destination is equal to or less than −5° C.

In a case where there is the need for the cold region equipment (determination in S63 is Yes), the allocation processing unit 14 narrows down the candidate vehicles to the shared vehicles 2 provided with the cold region equipment as new vehicle candidates (S64). On the other hand, in a case where there is no need for the cold region equipment (the determination in S63 is No), the allocation processing unit 14 proceeds to S67 without narrow down the candidate vehicles.

In a case where one or more candidate vehicles are present after narrowing down in S64 (the determination in S65 is Yes), the allocation processing unit 14 stores the candidate vehicles after narrowing down in S64 as the latest candidate vehicles (S66). On the other hand, in a case where no candidate vehicle is present after narrowing down in S64 (the determination in S65 is No), the allocation processing unit 14 stores the candidate vehicles before narrowing down in S64 as the latest candidate vehicles (S67). Further, in a case where there is no need for the cold region equipment (the determination in S63 is No), the allocation processing unit 14 stores the candidate vehicles before narrowing down in S64 as the latest candidate vehicles (S67).

According to the fifth narrowing subroutine, the candidate vehicles are narrowed down to the shared vehicles 2 provided with the cold region equipment for the user heading for the cold region. Thus, the shared vehicle 2 provided with the cold region equipment is more likely to be allocated to the user heading for the cold region, even if this user forgets to request the cold region equipment.

(The Sixth Narrowing Subroutine)

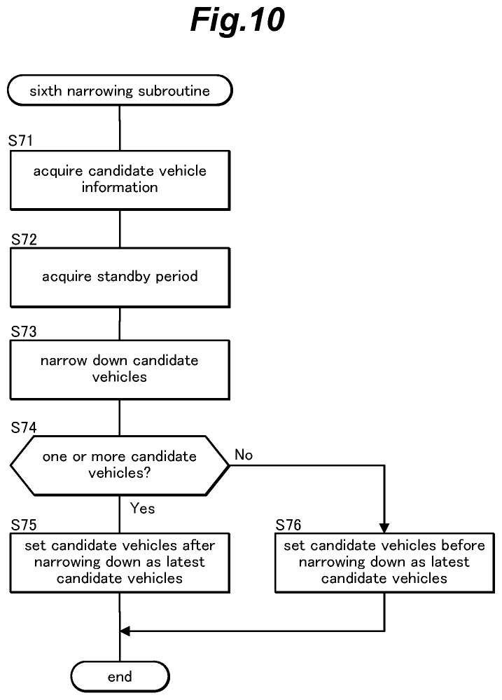

In the sixth narrowing subroutine, the allocation processing unit 14 further narrows down the candidate vehicles based on the use history included in the shared vehicle information. As shown in FIG. 10, in the sixth narrowing subroutine, the allocation processing unit 14 first acquires the latest candidate vehicle information (S71). In a case where the sixth narrowing subroutine is executed first in the narrowing process, the latest candidate vehicle information is the candidate vehicle information set in step S1. In a case where the sixth narrowing subroutine is executed second or later in the narrowing process, the latest candidate vehicle information is the candidate vehicle information set in the previous narrowing subroutine.

Next, the allocation processing unit 14 acquires the previous use date and time of each candidate vehicle based on the use history included in the shared vehicle information, and acquires a standby period of each candidate vehicle by subtracting the previous use date and time from the current date and time (S72). The standby period represents a period during which each candidate vehicle is waiting at the station without being used.

Next, the allocation processing unit 14 narrows down the candidate vehicles on condition that the standby period thereof is equal to or greater than a prescribed determination value (S73). In a case where one or more candidate vehicles are present after narrowing down in S73 (the determination in S74 is Yes), the allocation processing unit 14 stores the candidate vehicles after narrowing down in S73 as the latest candidate vehicles (S75). On the other hand, in a case where no candidate vehicle is present after narrowing down in S73 (the determination in S74 is No), the allocation processing unit 14 stores the candidate vehicles before narrowing down in S73 as the latest candidate vehicles (S76).

According to the sixth narrowing subroutine, the shared vehicle 2 with a long standby period is more likely to be allocated to the user. Accordingly, the standby period of each shared vehicle 2 is reduced, so that the battery of each shared vehicle 2 can be prevented from discharging too much.

In S11, one or more subroutines to be executed are selected from the abovementioned first to sixth narrowing subroutines and the execution order thereof is set based on the allocation policy information. For example, as a result of the setting in S11, all the first to sixth narrowing subroutines may be executed in ascending order. Alternatively, only one narrowing subroutine selected from the first to sixth narrowing subroutines may be executed.

The function of the car sharing service provided by the shared vehicle managing system 1 with the abovementioned configuration will be described. Each user makes the use application by performing the input operation on the reservation accepting screen (use application screen) of each user terminal 3. At this time, the user does not have to select the shared vehicle 2 to board, and inputs the basic information such as the use start date and time, the use end date and time, and the station to be used. The input of the basic information is essential. Further, the user inputs the additional information including the information about the scheduled travel distance, the request for equipment, and the like. The input of the additional information is optional, and the user inputs the additional information as needed. The user terminal 3 generates the use application information in response to the input operation by the user, and transmits the use application information to the managing server 6.

Upon receiving the use application information, the reservation managing unit 13 of the managing server 6 generates the allocation process request, and outputs the allocation process request and the use application information to the allocation processing unit 14. Upon receiving the allocation process request, the allocation processing unit 14 determines the shared vehicle 2 to be allocated to the user and outputs the information about the shared vehicle 2 to be allocated to the reservation managing unit 13 as the allocation result. The reservation managing unit 13 determines the success/failure of the reservation based on the allocation result and transmits the success/failure of the reservation to each user terminal 3 as the reservation result information. The user terminal 3 displays the reservation result information, thereby notifying the user of the success/failure of the reservation.

The administrator operates the administrator terminal 5, thereby generating the allocation policy information. In the narrowing process, the narrowing subroutines to be executed are selected and the execution order thereof is changed based on the allocation policy information. Accordingly, the request of the administrator can be reflected in the allocation process.

In the shared vehicle managing system 1 according to the present embodiment, each user does not have to select the shared vehicle 2 to board when making the use application, thereby smoothly making the use application. Thus, the convenience of the shared vehicle managing system 1 can be improved. Further, for example, the shared vehicle 2 having the remaining amount of energy corresponding to the scheduled travel distance may be allocated to the user or the shared vehicle 2 provided with the cold region equipment may be allocated to the user, even if the user does not designate the shared vehicle 2. Accordingly, the user can comfortably use the shared vehicle 2.

Further, the shared vehicle managing system 1 controls the allocation of the shared vehicle 2 by various narrowing subroutines. Accordingly, it is possible to prevent the use frequency of some shared vehicles 2 and the total travel distances thereof from increasing.

Concrete embodiments of the present invention have been described in the foregoing, but the present invention should not be limited by the foregoing embodiments and various modifications and alterations are possible within the scope of the present invention. For example, the allocation policy information may include information for changing the determination value of each narrowing subroutine. According to this arrangement, the magnitude of the effect of each narrowing subroutine can be changed.

The reservation managing unit 13, the user information managing unit 11, the shared vehicle information managing unit 12, the allocation processing unit 14, and the weather information managing unit 16 may be provided in different servers connected to each other via the network 7.

### Glossary of Terms

1: shared vehicle managing system
2: shared vehicle
3: user terminal
4: onboard terminal
5: administrator terminal
6: managing server
7: network
9: vehicle state detecting device
11: user information managing unit
12: shared vehicle information managing unit
13: reservation managing unit
14: allocation processing unit
15: driving skill acquiring unit
16: weather information managing unit

1. A shared vehicle managing system for renting a plurality of shared vehicles to a plurality of users, comprising:
a plurality of user terminals configured to generate use application information in response to an input operation by each user; and
a managing server connected to the user terminals via a network,
wherein the managing server includes an allocation processing unit configured to allocate one shared vehicle to a user based on the use application information, and
the use application information does not include information about designation of the one shared vehicle but includes information about a scheduled travel distance.

2. The shared vehicle managing system according to claim 1, wherein the managing server includes a shared vehicle information managing unit configured to store vehicle information about each shared vehicle,
the vehicle information includes information about whether each shared vehicle is a long-distance vehicle, and
the allocation processing unit is configured to acquire the scheduled travel distance based on the use application information and to allocate the one shared vehicle preset as the long-distance vehicle to the user in a case where the scheduled travel distance is longer than a prescribed determination value.

3. The shared vehicle managing system according to claim 1, wherein the managing server includes a shared vehicle information managing unit configured to store vehicle information about each shared vehicle,
the vehicle information includes at least one of a total travel distance and a remaining amount of energy, and
the allocation processing unit is configured to allocate the one shared vehicle to the user based on the use application information and the vehicle information.

4. The shared vehicle managing system according to claim 3, wherein the allocation processing unit is configured to calculate a travel distance difference by subtracting the total travel distance from a target total travel distance set for each shared vehicle according to an operation period thereof and to allocate the one shared vehicle with a large travel distance difference to the user.

5. The shared vehicle managing system according to claim 3, wherein the allocation processing unit is configured to acquire the scheduled travel distance based on the use application information, to set a travelable distance for each shared vehicle based on the remaining amount of the energy, and to allocate the one shared vehicle to the user, a difference between the travelable distance of the one shared vehicle and the scheduled travel distance thereof being within a prescribed range.

6. The shared vehicle managing system according to claim 3, wherein the use application information includes destination information,
the vehicle information includes information about whether each shared vehicle is provided with cold region equipment, and
the allocation processing unit is configured to acquire weather information about a destination in a use period based on the destination information, to determine whether there is a need for the cold region equipment based on the weather information, and to allocate the one shared vehicle provided with the cold region equipment to the user in a case where there is the need for the cold region equipment.

7. The shared vehicle managing system according to claim 1, wherein the managing server includes a user information managing unit configured to store driving skill information about a driving skill of each user, and
the allocation processing unit is configured to allocate the one shared vehicle to the user based on the use application information and the driving skill information.

8. The shared vehicle managing system according to claim 1, wherein the managing server includes a shared vehicle information managing unit configured to store vehicle information about each shared vehicle,
the vehicle information includes a use history of each shared vehicle, and
the allocation processing unit is configured to acquire a standby period of each shared vehicle based on the use history and to allocate the one shared vehicle to the user, the standby period of the one shared vehicle being longer than a prescribed determination value.

9. The shared vehicle managing system according to claim 1, further comprising an administrator terminal connected to the managing server via the network and configured to generate allocation policy information in response to an input operation by an administrator,
wherein the allocation processing unit is configured to allocate the one shared vehicle to the user also based on the allocation policy information.
